(19) United States
(12) Patent Application Publication
(10) Pub. No.: US 2008/0312862 A1
(43) Pub. Date: Dec. 18, 2008

(54) METHOD AND SYSTEM FOR DETERMINING A FUEL USAGE OF A FIRST VEHICLE AND A COMPARATOR VEHICLE

(75) Inventors: Steven Yellin Schondorf, Dearborn, MI (US); Scott Howard Gaboury, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES LLC, Dearborn, MI (US)

(21) Appl. No.: 11/761,576

(22) Filed: Jun. 12, 2007

(51) Int. Cl. G01M 17/00; G01M 13/00

(52) U.S. Cl. 702/108

(57) ABSTRACT

A fuel usage of a comparator vehicle is calculated and compared to a fuel usage of a vehicle being driven. The fuel usage of the comparator vehicle is determined based on parameters of the vehicle being driven.

### BACKGROUND OF THE INVENTION

1. Field of the Invention

The invention relates to methods and systems for determining a fuel usage of a first vehicle and a comparator vehicle.

2. Discussion

A driver may wish to know how much fuel, if any, they have saved by driving one type of vehicle as compared to another. A driver may also wish to know the amount of emissions they have generated by driving one type of vehicle as compared to another.

### SUMMARY

Embodiments of the invention may take the form of a method for determining whether a fuel usage of a first vehicle is less than a fuel usage of a baseline vehicle. The method includes determining a measure of fuel usage for the first vehicle and determining a measure of fuel usage for a baseline vehicle based on a state of the first vehicle. The method also includes indicating whether the fuel usage of the first vehicle is less than the fuel usage of the baseline vehicle following.

Embodiments of the invention may take the form of a system for determining whether a fuel usage of a first vehicle is less than a fuel usage of a baseline vehicle. The system includes at least one processing module configured to determine a measure of fuel usage for the first vehicle and determine a measure of fuel usage for a baseline vehicle based on a state of the first vehicle. The at least one processing module is also configured to indicate whether the fuel usage of the first vehicle is less than the fuel usage of the baseline vehicle.

### BRIEF DESCRIPTION OF THE DRAWINGS

FIG. 1 is a flow chart of a method for rewarding a driver of a vehicle that has achieved a desirable fuel usage vis-à-vis a comparator in accordance with an embodiment of the invention.

FIG. 2 is a flowchart of a method for determining vehicle fuel used, fuel economy, and CO₂ emitted in accordance with an embodiment of the invention.

FIG. 3 is a plot of fuel used versus time as determined with reference to FIG. 2.

FIG. 4 is a flowchart of a method for determining comparator fuel usage in accordance with an embodiment of the invention.

FIG. 5 is a tabular representation of a mapping between vehicle speed and wheel torque request and comparator engine torque and engine speed in accordance with an embodiment of the invention.

FIG. 6 is a graphical representation of a mapping between comparator fuel flow versus comparator engine torque and engine speed in accordance with an embodiment of the invention.

FIG. 7 is a plot of vehicle fuel used and comparator fuel used versus time as determined with reference to FIGS. 2 and 6.

FIG. 8 is a block diagram of several vehicle controllers and shows the relationships between inputs and outputs of the controllers over time.

FIG. 9 is a block diagram of several vehicle controllers and shows the communicative relationship between a vehicle system controller, powertrain control module, and memory.

FIG. 10 is a block diagram of several vehicle controllers and shows the relationships between inputs and outputs of the controllers over time.

### DETAILED DESCRIPTION

Embodiments of the invention may provide a controller that acts as a fuel/emissions odometer. The controller may keep a running total of, for example, fuel saved as compared to another vehicle. When certain fuel saving marks are achieved, e.g., 1000 gallons, the driver may be notified via a congratulatory message and an authentication code. The driver may then be able to apply for awards, e.g., an emblem for their vehicle, via the authentication code. For vehicles including telematics infrastructure, this process could be automated so that the vehicle itself would broadcast that the driver has reached a milestone. Alternatively, the award could be based on driver self-certification.

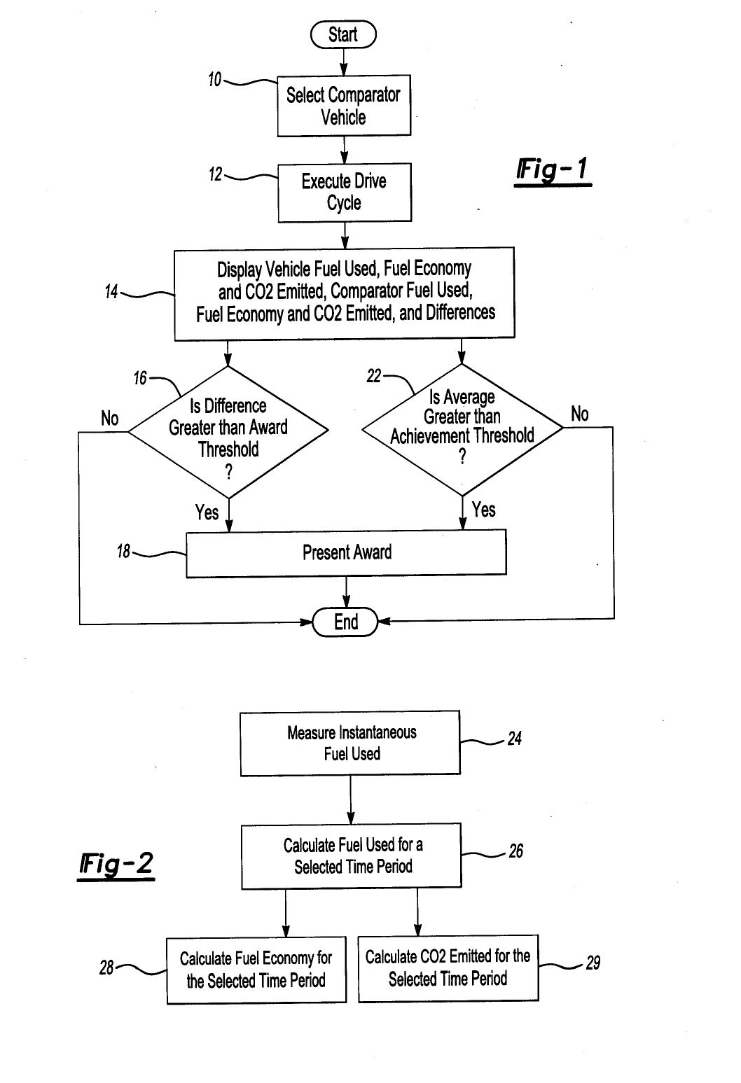

FIG. 1 is a flow chart of a method for rewarding a driver of a vehicle that has achieved a desirable fuel usage vis-à-vis a comparator. In the embodiment of FIG. 1, the vehicle is a hybrid electric vehicle (HEV) and the comparator vehicle is a conventional powertrain version (CON) of the HEV. In other embodiments, the vehicle and comparator may be of any type or configuration.

At 10, the driver of the vehicle, e.g., HEV, selects the comparator vehicle, e.g., CON, by, for example, selecting it from a list presented to the driver via a display. At 12, the driver executes a drive cycle. This drive cycle may be a commuting route or any other route. At 14, during, and/or at the end of, the drive cycle, the fuel used, fuel economy, and/or CO₂ emitted by the HEV and the CON, as well as the difference(s) between them, are displayed to the driver. At 16, at the completion of the drive cycle, if the fuel used, fuel economy, and/or CO₂ emitted by the HEV are better than that of the CON by some predetermined amount, e.g., 20%, then at 18, the driver is presented with an award via a display, e.g., discounts toward the purchase of a new vehicle, etc. At 22, if the average fuel used, fuel economy, and/or CO₂ emitted are better than an achievement threshold, e.g., 40 miles/gallon, then at 18, the driver is presented with an award via a display.

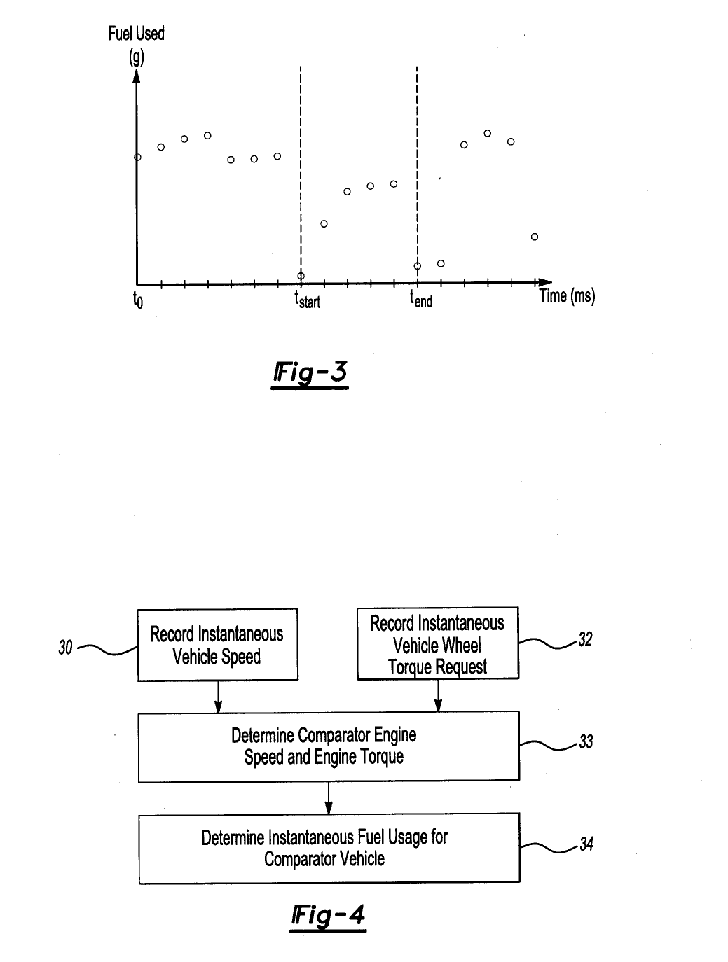

FIG. 2 is a flowchart of a method for determining vehicle fuel used, fuel economy, and CO₂ emitted. At 24, the instantaneous fuel used by the HEV is measured by, for example, measuring the injector fuel flow pulses every 20 milliseconds. This data is represented in the plot of FIG. 3.

At 26, the fuel used during a time period is calculated using, for example, the following relation:

$$FUEL USED = {\sum }_{tstart}^{tend} {F}_{t}$$

where
Fₜ=instantaneous fuel usage
tₛₜₐᵣₜ=start of time period
t_{end}=end of time period
A start time may be that time at which a drive cycle begins and may be selected by the driver. For example, the driver may choose the start time to be at vehicle start-up. An end time may be that time at which a drive cycle ends and may be selected by the driver. For example, the driver may choose the end time to be at vehicle shut-down. As such, the fuel used for a drive cycle can be calculated. The driver may also concurrently choose a start time to be at vehicle purchase and an end time to be the current time. As such, the fuel used to date can be calculated. The driver may thus select any number of start and end times.

At 28, the fuel economy during the time period is calculated using, for example, the following relation:

$$FUEL ECONOMY = \frac{FUEL USED}{DISTANCE TRAVELED}$$

where
DISTANCE TRAVELED=distance traveled from tₛₜₐᵣₜ to t_{end}
Distance information may be available from, for example, odometer readings as measured from wheel speed sensors or transmission output shaft sensors. As such, the fuel economy during any time period, including instantaneous fuel economy, may be calculated.

At 29, the CO₂ emitted during the time period is calculated using, for example, the following relation:

CO₂ EMITTED=ζ·FUEL USED

where
ζ=a fuel specific constant
ζ may be determined experimentally for a given fuel by measuring the CO₂ emitted for a given amount of fuel used.

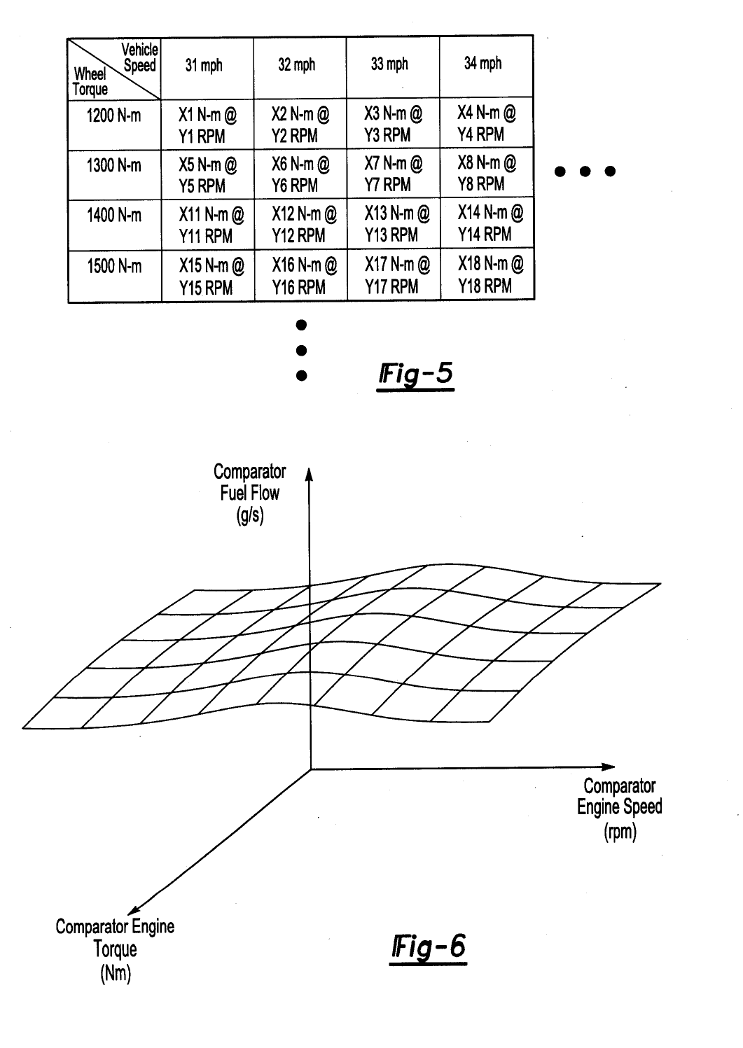

FIG. 4 is a flowchart of a method for determining comparator fuel usage. At 30, the instantaneous vehicle speed of the HEV is recorded. At 32, the instantaneous wheel torque request of the HEV is recorded. At 33, as explained with reference to FIG. 5, the instantaneous engine speed and engine torque of the CON is determined. At 34, as explained with reference to FIG. 6, the instantaneous fuel flow of the CON is determined.

FIG. 5 is a tabular representation of a mapping between vehicle speed and wheel torque request and comparator engine torque and engine speed. The data to generate this mapping may be acquired, for example, through testing, simulation, or interrogation of the CON at various known vehicle speeds and wheel torque requests. This mapping, which is stored by the HEV, permits the translation of HEV vehicle speed and wheel torque request to CON engine torque and engine speed. In alternative embodiments, other HEV parameters, e.g., engine torque, motor torque, may also be used as engine torque and motor torque are based on wheel torque request as explained with reference to FIGS. 8 and 10.

FIG. 6 is a graphical representation of a mapping between comparator fuel flow versus comparator engine torque and engine speed. The data to generate this mapping may be acquired, for example, through testing, simulation, or interrogation of the CON at various known engine torques and engine speeds. This mapping, which is stored by the HEV, permits the translation of CON engine torque and engine speed to CON fuel flow.

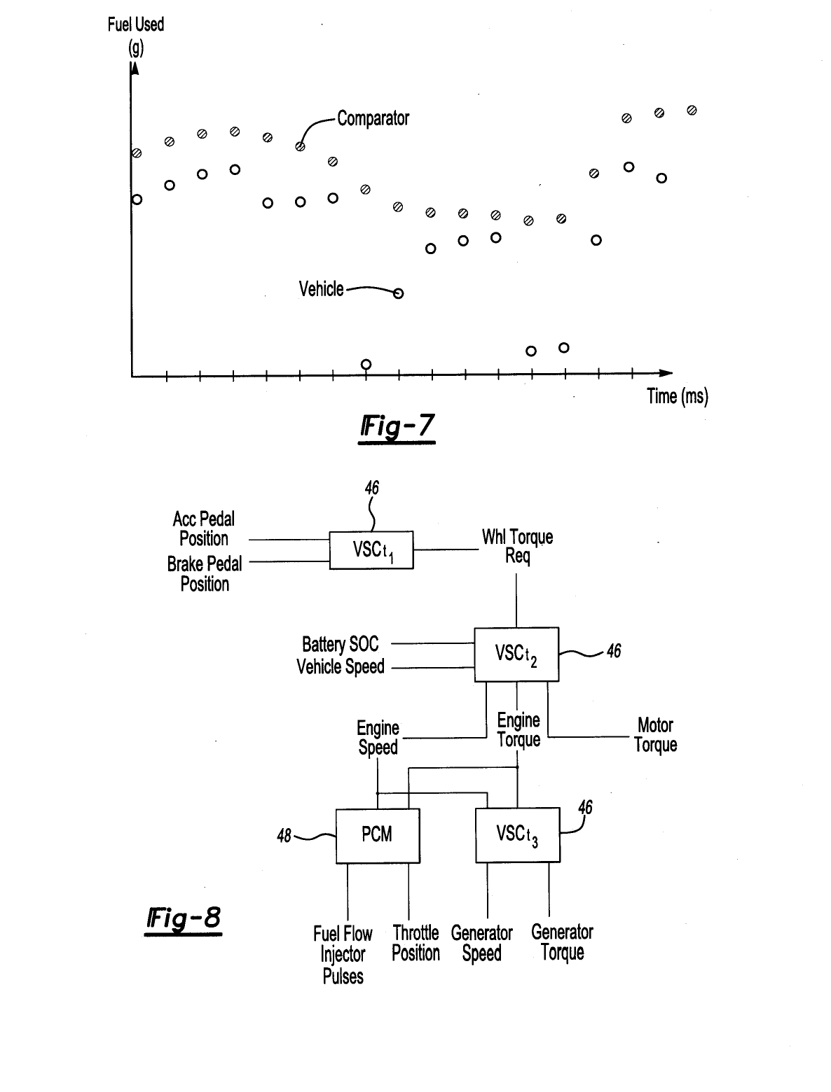

FIG. 7 is a plot of vehicle fuel used and comparator fuel used versus time as determined with reference to FIGS. 2 and 6. This data, which is stored by the HEV, may be used to calculate differences in fuel used for any time period. For example, the techniques discussed with reference to FIG. 2 may be used to calculate the fuel used of the HEV and the fuel used of the CON and by subtracting one from the other, the difference in fuel used may be calculated. This data may also be used to calculate differences in fuel economy for any time period. For example, the techniques discussed with reference to FIG. 2 may be used to calculate the fuel economy of the HEV and the fuel economy of the CON and by subtracting one from the other, the difference in fuel economy may be calculated. This data may also be used to calculate differences in CO₂ emitted for any time period. For example, the techniques discussed with reference to FIG. 2 may be used to calculate the CO₂ emitted by the HEV and the CO₂ emitted by the CON and by subtracting one from the other, the difference in CO₂ emitted may be calculated.

FIG. 8 is a block diagram of several vehicle controllers and shows the relationships between inputs and outputs of the controllers over time. The inputs and outputs of the several controllers may be monitored and used to determine, for example, fuel usage of the CON as described with reference to FIGS. 4, 5, and 6.

Accelerator pedal position and brake pedal position are input to vehicle system controller 46 at t₁. Vehicle system controller 46 determines wheel torque request based on accelerator pedal position and brake pedal position. Battery state of charge and vehicle speed are input to vehicle system controller 46 at t₂. Vehicle system controller 46 determines engine speed, engine torque, and motor torque based on battery state of charge and vehicle speed, as well as other applicable parameters, e.g., auxiliary loads. Engine speed and engine torque are input to powertrain control module 48. Powertrain control module 48 determines fuel flow injector pulses and throttle position based on engine speed, engine torque, and motor torque. Engine speed, engine torque, and motor torque are input to vehicle system controller 46 at t₃. Vehicle system controller 46 determines generator speed and generator torque based on engine speed, engine torque, and motor torque.

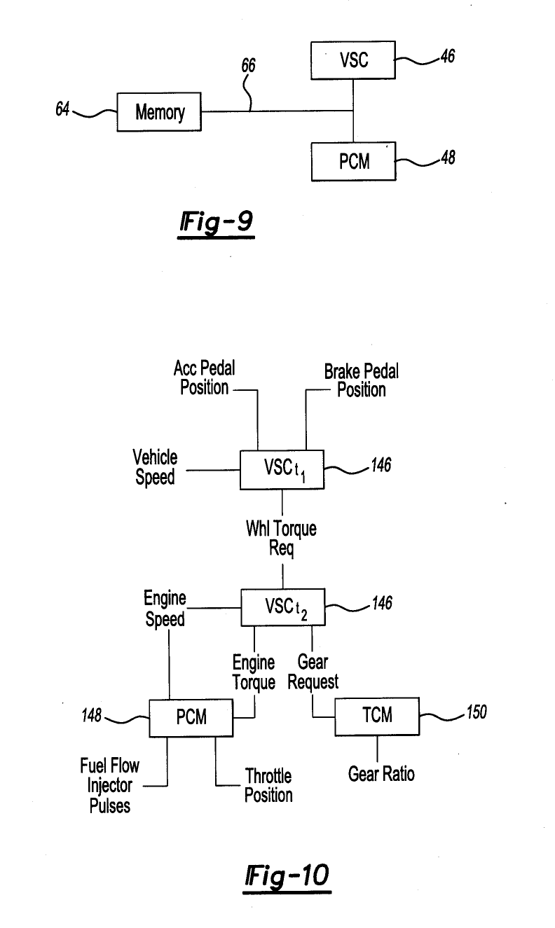

FIG. 9 is a block diagram of several vehicle controllers and shows the communicative relationship between a vehicle system controller, powertrain control module, and memory. The methods described herein may be performed, for example, by vehicle system controller 46 or some combination of controllers.

Vehicle system controller 46 may have fuel flow injector pulse information communicated to it from powertrain control module 48. Vehicle system controller 46 may store such information locally or in memory 64 accessible via network 66. Data of the type shown in FIGS. 3, 5, 6, and 7 may also be stored in memory 64 and made available via network 66. As such, vehicle system controller 46 has access to the data necessary to perform the methods described herein. Other configurations, however, are also contemplated, e.g., vehicle system controller 46 and powertrain control module 48 collectively perform the methods described herein, etc.

FIG. 10 is a block diagram of several vehicle controllers and shows the relationships between inputs and outputs of the controllers over time. Numbered elements differing by factors of 100 have similar, although not necessarily identical, descriptions, e.g., vehicle system controllers 46, 146 have similar descriptions.

Accelerator pedal position, brake pedal position, and vehicle speed are input to vehicle system controller 146 at t₁. Vehicle system controller 146 determines wheel torque request based on accelerator pedal position, brake pedal position, and vehicle speed. Wheel torque request is input to vehicle system controller 146 at t₂. Vehicle system controller 146 determines engine speed, engine torque, and gear request based on wheel torque request. Engine speed and engine torque are input to powertrain control module 148. Powertrain control module 148 determines fuel flow injector pulses and throttle position based on engine speed and engine torque. Gear request is input to transmission control module 150. Transmission control unit 150 sets gear ratio based on gear request. Other configurations are also contemplated.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method for determining whether a fuel usage of a first vehicle is less than a fuel usage of a baseline vehicle, the method comprising:
determining a measure of fuel usage for the first vehicle;
determining a measure of fuel usage for a baseline vehicle based on a state of the first vehicle;
determining whether the fuel usage of the first vehicle is less than the fuel usage of the baseline vehicle based on the measures of fuel usage; and
indicating whether the fuel usage of the first vehicle is less than the fuel usage of the baseline vehicle.

2. The method of claim 1 wherein the measure of fuel usage of the first vehicle comprises fuel consumed by the first vehicle.

3. The method of claim 1 wherein the measure of fuel usage of the first vehicle comprises fuel economy of the first vehicle.

4. The method of claim 1 wherein the measure of fuel usage of the first vehicle comprises an amount of fuel consumption gas emitted by the first vehicle.

5. The method of claim 4 wherein the fuel consumption gas comprises CO₂.

6. The method of claim 1 wherein the state of the first vehicle comprises a wheel torque request.

7. The method of claim 1 wherein the state of the first vehicle comprises vehicle speed.

8. The method of claim 1 wherein the state of the first vehicle comprises an engine torque.

9. The method of claim 1 wherein the state of the first vehicle comprises a motor torque.

10. The method of claim 1 further comprising displaying at least one of the measures of fuel usage.

11. The method of claim 1 further comprising issuing a reward to the driver of the first vehicle if the fuel usage of the first vehicle is less than the fuel usage of the baseline vehicle.

12. A system for determining whether a fuel usage of a first vehicle is less than a fuel usage of a baseline vehicle, the system comprising:
at least one processing module configured to
determine a measure of fuel usage for the first vehicle,
determine a measure of fuel usage for a baseline vehicle based on a state of the first vehicle,
determine if the fuel usage of the first vehicle is less than the fuel usage of the baseline vehicle based on the measures of fuel usage, and
indicate whether the fuel usage of the first vehicle is less than the fuel usage of the baseline vehicle.

13. The system of claim 12 wherein the measure of fuel usage of the first vehicle comprises fuel consumed by the first vehicle.

14. The system of claim 12 wherein the measure of fuel usage of the first vehicle comprises fuel economy of the first vehicle.

15. The system of claim 12 wherein the measure of fuel usage of the first vehicle comprises an amount of fuel consumption gas emitted by the first vehicle.

16. The system of claim 15 wherein the fuel consumption gas comprises CO₂.

17. The method of claim 12 wherein the state of the first vehicle comprises a wheel torque request.

18. The method of claim 12 wherein the state of the first vehicle comprises vehicle speed.

19. The method of claim 12 wherein the state of the first vehicle comprises an engine torque.

20. The method of claim 12 wherein the state of the first vehicle comprises a motor torque.
